(19) United States
(12) Patent Application Publication
(10) Pub. No.: US 2016/0103343 A1
(43) Pub. Date: Apr. 14, 2016

(54) OPTICAL PATH CONVERTING ELEMENT AND DISPLAY DEVICE INCLUDING THE SAME

(71) Applicant: SAMSUNG DISPLAY CO., LTD., Yongin-City (KR)

(72) Inventors: SEONG MIN CHO, Seongnam-si (KR); Soo Hee Oh, Hwaseong-si (KR); Seung Jun Jeong, Hwaseong-si (KR)

(21) Appl. No.: 14/699,510

(22) Filed: Apr. 29, 2015

(30) Foreign Application Priority Data
Oct. 8, 2014 (KR) 10-2014-0136209

(51) Int. Cl. G02F 1/137; G02F 1/13363; G02B 27/22

(52) U.S. Cl. CPC G02F 1/137; G02B 27/2214; G02F 1/13363; G02F 2001/133638

(57) ABSTRACT

The present invention provides an optical path converting element. The optical path converting element includes a first layer, a second layer, and a liquid crystal layer. The first layer includes at least one first-layer electrode. The second layer includes at least one second-layer electrode. The liquid crystal layer is interposed between the first layer and the second layer. Liquid crystal of the liquid crystal layer has a first state or a second state in accordance with a voltage applied to the first-layer and second layer electrodes. The liquid crystal of the liquid crystal layer is vertically aligned in the first state. The liquid crystal of the liquid crystal layer is horizontally aligned in the second state. The liquid crystal of the liquid crystal layer is spirally aligned in a first direction in the second state. The liquid crystal of the liquid crystal layer has chirality.

### CROSS-REFERENCE TO RELATED APPLICATION

This application claims priority under 35 U.S.C. §119 to Korean Patent Application No. 10-2014-0136209, filed on Oct. 8, 2014 in the Korean Intellectual Property Office, the disclosure of which is incorporated by reference herein in its entirety.

### TECHNICAL FIELD

The present invention relates to an optical path converting element and, more particularly, to a display device including the same.

### DISCUSSION OF THE RELATED ART

A liquid crystal driving mode optical system (e.g., a liquid crystal driving mode optical path converting element) which converts an optical path in accordance with a voltage applying mode has been developed.

Applications of the liquid crystal driving mode optical path converting element may include a three-dimensional (3D) stereoscopic image display device. To implement a stereoscopic image display device, different two-dimensional (2D) images may be projected onto a left eye and a right eye, respectively.

In an autostereoscopic image display device, when the liquid crystal driving mode optical path converting element is used, both the 3D image and the 2D image may be provided to the viewer.

However, the liquid crystal driving mode optical path converting element may have different phase retardation values depending on wavelengths of incident light and thus, diffraction efficiency thereof may vary depending on the wavelengths of light.

FIGS. 11 to 13 illustrate a phase retardation value and a diffraction efficiency value of the liquid crystal driving mode optical path converting element in a parallel VA (Pa-VA) mode in accordance with a red wavelength (633 nm), a green wavelength (555.5 nm), and a blue wavelength (473 nm). In the case of a general Pa-VA mode, the phase retardation value may be set for the green wavelength, and thus, the diffraction efficiency thereof may be lowered in the red and blue wavelengths.

Therefore, there may be a demand for the liquid crystal driving mode optical path converting element in an achromatic mode which does not have a wavelength dispersion characteristic. Thus, chromatic aberration might not be caused.

To manufacture an achromatic polarization grating, as illustrated in FIGS. 14A through 14D, firstly, linear-photopolymerizable polymer (LPP) or Azo-dye may be coated with an alignment layer and then spirally aligned by polarization holography. Further, a reactive mesogen (RM) alignment layer in which chiral dopant is mixed may be coated thereon and then photopolymerization may be performed thereon.

### SUMMARY OF THE INVENTION

According to an exemplary embodiment of the present invention, an optical path converting element is provided. The optical path converting element includes a first layer, a second layer, and a liquid crystal layer. The first layer includes at least one first-layer electrode. The second layer includes at least one second-layer electrode. The liquid crystal layer is interposed between the first layer and the second layer. Liquid crystal of the liquid crystal layer has a first state or a second state in accordance with a voltage which is applied to the first-layer and second-layer electrodes. The liquid crystal of the liquid crystal layer is vertically aligned in the first state. The liquid crystal of the liquid crystal layer is horizontally aligned in the second state. The liquid crystal of the liquid crystal layer is spirally aligned along a first direction in the second state. The liquid crystal of the liquid crystal layer has chirality.

In an exemplary embodiment of the present invention, the liquid crystal of the liquid crystal layer may be spirally aligned in a clockwise direction in a plan view along the first direction in the second state to form a first optical path converting unit, and the liquid crystal of the liquid crystal layer may be spirally aligned in a counterclockwise direction in the plan view along the first direction in the second state to form a second optical path converting unit.

In an exemplary embodiment of the present invention, the liquid crystal of the liquid crystal layer may be spirally aligned in a counterclockwise direction in a plan view along the first direction in the second state to form a first optical path converting unit, and the liquid crystal of the liquid crystal layer may be spirally aligned in a clockwise direction in the plan view along the first direction in the second state to form a second optical path converting unit.

According to an exemplary embodiment of the present invention, an optical path converting element is provided. The optical path converting element includes a first layer, a second layer, and a liquid crystal layer. The first layer includes at least one first-layer electrode. The second layer includes at least one second-layer electrode. The liquid crystal layer is interposed between the first layer and the second layer. The liquid crystal layer has a first region and a second region. Liquid crystal of the liquid crystal layer has a first state, a second state, or a third state in accordance with a voltage which is applied to the first-layer and second-layer electrodes. The liquid crystal of the liquid crystal layer is vertically aligned in the first state. The liquid crystal of the liquid crystal layer is horizontally aligned in the second state. The liquid crystal of the liquid crystal layer is spirally aligned in a first direction in the second state. The liquid crystal of the liquid crystal layer is horizontally aligned in the third state. The liquid crystal of the liquid crystal layer is spirally aligned in a second direction different from the first direction in the third state. The liquid crystal of the liquid crystal layer has chirality. The liquid crystal of the liquid crystal layer forms a first optical path converting unit which has the first state or the second state in the first region. The liquid crystal of the liquid crystal layer forms a second optical path converting unit which has the first state or the third state in the second region.

In an exemplary embodiment of the present invention, the first optical path converting unit or the second optical path converting unit may be disposed in a form of a Fresnel lens.

In an exemplary embodiment of the present invention, the first optical path converting unit or the second optical path converting unit may be disposed in a form of a lenticular lens.

In an exemplary embodiment of the present invention, a size of the first optical path converting unit or the second optical path converting unit may vary depending on a voltage which is applied to the first-layer and second-layer electrodes.

In an exemplary embodiment of the present invention, chirality of the liquid crystal of the first optical path converting unit may be different from chirality of the liquid crystal of the second optical path converting unit.

In an exemplary embodiment of the present invention, a direction of the liquid crystal of the first optical path converting unit may be opposite to a direction of the liquid crystal of the second optical path converting unit.

In an exemplary embodiment of the present invention, the chirality of the liquid crystal of the liquid crystal layer may be obtained by adding chiral dopant.

According to an exemplary embodiment of the present invention, a stereoscopic image display device is provided. The stereoscopic image display device includes a display panel, a wave plate, and an optical path converting element. The wave plate is disposed on the display panel. The optical path converting element is disposed on the wave plate. The optical path converting element includes a first layer, a second layer, and a liquid crystal layer. The first layer includes at least one first-layer electrode. The second layer includes at least one second-layer electrode. The liquid crystal layer is interposed between the first layer and the second layer. The liquid crystal layer has a first region and a second region. Liquid crystal of the liquid crystal layer has a first state, a second state, or a third state in accordance with a voltage which is applied to the first-layer and second-layer electrodes. The liquid crystal of the liquid crystal layer is vertically aligned in the first state. The liquid crystal of the liquid crystal layer is horizontally aligned in the second state. The liquid crystal of the liquid crystal layer is spirally aligned in a first direction in the second state. The liquid crystal of the liquid crystal layer is horizontally aligned in the third state. The liquid crystal of the liquid crystal layer is spirally aligned in a second direction different from the first direction in the third state. The liquid crystal of the liquid crystal layer has chirality. The liquid crystal of the liquid crystal layer forms a first optical path converting unit which has the first state or the second state in the first region. The liquid crystal of the liquid crystal layer forms a second optical path converting unit which has the first state or the third state in the second region.

According to an exemplary embodiment of the present invention, an optical path converting element is provided. The optical path converting element includes a first layer, a second layer, and a liquid crystal layer. The first layer includes at least one first-layer electrode. The second layer includes at least one second-layer electrode. The liquid crystal layer is interposed between the first layer and the second layer. Liquid crystal of the liquid crystal layer has a first state or a second state in accordance with a voltage which is applied to the first-layer and second layer electrodes. The liquid crystal of the liquid crystal layer is vertically aligned in the first state. The liquid crystal of the liquid crystal layer is horizontally aligned in the second state. The liquid crystal of the liquid crystal layer is spirally aligned in a first direction in the second state. The liquid crystal of the liquid crystal layer has different spiral alignments in accordance with a height in the second state.

In an exemplary embodiment of the present invention, the liquid crystal of the liquid crystal layer may have different spiral alignments having different twisted degrees in accordance with the height in the second state.

According to an exemplary embodiment of the present invention, an optical path converting element is provided. The optical path converting element includes a first layer, a second layer, and a liquid crystal layer. The first layer includes a first electrode and a second electrode. The second layer includes a third electrode. The liquid crystal layer is interposed between the first layer and the second layer. Liquid crystal of the liquid crystal layer forms a first optical path converting unit or a second optical path converting unit by applying voltages to the first through third electrodes of the first and second layers. The first optical path converting unit is formed by applying a first voltage to the first electrode and a second voltage higher than the first voltage to the second electrode. The second optical path converting unit is formed by applying the second voltage to the first electrode and the first voltage to the second electrode.

In an exemplary embodiment of the present invention, the liquid crystal of the liquid crystal layer may have chirality.

In an exemplary embodiment of the present invention, the first optical path converting unit may have the liquid crystal of the liquid crystal layer spirally aligned in one of a clockwise direction or a counterclockwise direction along a first direction.

In an exemplary embodiment of the present invention, the second optical path converting unit may have the liquid crystal of the liquid crystal layer spirally aligned in an opposite direction to the first optical path converting unit.

In an exemplary embodiment of the present invention, the first optical path converting unit or the second optical path converting unit may be disposed in a form of a Fresnel lens.

In an exemplary embodiment of the present invention, the first optical path converting unit or the second optical path converting unit may be disposed in a form of a lenticular lens.

In an exemplary embodiment of the present invention, a size of the first optical path converting unit or the second optical path converting unit may vary depending on levels of the first through third voltages.

### BRIEF DESCRIPTION OF THE DRAWINGS

A more complete appreciation of the present invention and many of the attendant aspects thereof will be readily obtained as the same becomes better understood by reference to the following detailed description when considered in connection with the accompanying drawings, wherein:

FIG. 1A is a view illustrating an optical path converting element according to an exemplary embodiment of the present invention;

FIG. 1B is a view illustrating a stereoscopic image display device which includes an optical path converting element according to an exemplary embodiment of the present invention;

FIG. 2 is a view illustrating a shape of a lenticular lens according to an exemplary embodiment of the present invention;

FIG. 3 is a view illustrating a phase distribution of a liquid crystal driving mode Fresnel lens according to an exemplary embodiment of the present invention;

FIG. 4A is a side view illustrating a first optical path converting unit according to an exemplary embodiment of the present invention;

FIG. 4B is a plain view illustrating a liquid crystal layer of a first optical path converting unit according to an exemplary embodiment of the present invention;

FIG. 5A is a side view illustrating a second optical path converting unit according to an exemplary embodiment of the present invention;

FIG. 5B is a plain view illustrating a liquid crystal layer of a second optical path converting unit according to an exemplary embodiment of the present invention;

FIG. 6 is a view illustrating a case when a first optical path converting unit has a left-handed chirality according to an exemplary embodiment of the present invention;

FIG. 7 is a view illustrating a case when a first optical path converting unit has a right-handed chirality according to an exemplary embodiment of the present invention;

FIG. 8 is a view illustrating a first optical path converting unit which does not have chirality according to an exemplary embodiment of the present invention;

FIG. 9 is a view illustrating a first optical path converting unit having right-handed chirality according to an exemplary embodiment of the present invention;

FIG. 10 is a view illustrating diffraction efficiency of an achromatic polarization grating and a circular polarization grating depending on a red wavelength, a green wavelength, and a blue wavelength;

FIGS. 11 to 13 are views illustrating a phase retardation value and a diffraction efficiency value in accordance with a red wavelength, a green wavelength, and a blue wavelength in a Pa-VA mode; and

FIGS. 14A through 14D are views illustrating a process of manufacturing an achromatic polarization.

### DETAILED DESCRIPTION OF THE EMBODIMENTS

Hereinafter, exemplary embodiments of the present invention will be described in detail with reference to accompanying drawings. Same reference numerals may designate same elements throughout the specification.

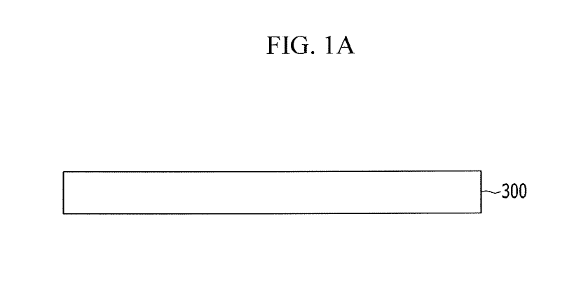

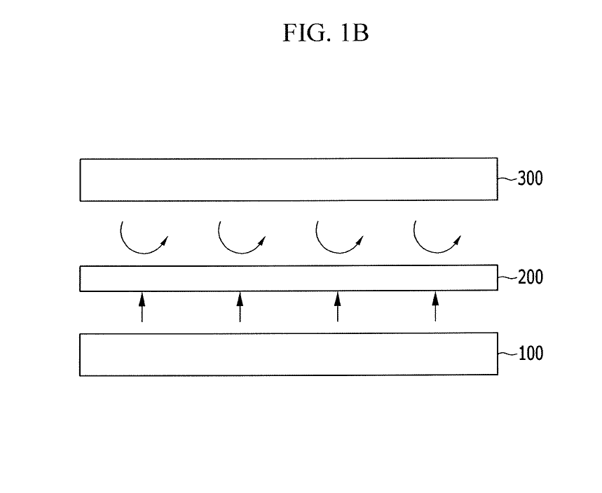

FIG. 1A is a view illustrating an optical path converting element 300 according to an exemplary embodiment of the present invention.

The optical path converting element 300 may be used not only in a stereoscopic image display device but also in various other fields. For example, the optical path converting element 30 may be used for remote sensing, biomedical imaging, optical communication, quantum computing, or the like. In addition, the optical path converting element 30 may be used where the optical path is converted.

The optical path converting element 300 may be a prism.

Here, the prism may be an element which changes a path of light. The prism may include a lens as a constituent unit.

The optical path converting element 300 may be a lens.

The optical path converting element 300 may include a plurality of prisms or a plurality of lenses. Functions of the optical path converting element 300 may vary in accordance with the arrangement patterns of the prisms or the lenses.

FIG. 1B is a view illustrating a stereoscopic image display device which includes an optical path converting element according to an exemplary embodiment of the present invention.

Referring to FIG. 1B, the stereoscopic image display device includes a display panel 100, a wave plate 200, and an optical path converting element 300.

The wave plate 200 is disposed on the display panel 100 and the optical path converting element 300 is disposed on the wave plate 200.

The display panel 100 may be any of known display devices. The display panel 100 may be any of devices, which output a still image or a motion picture which is recognized by a viewer, such as a plasma display, a liquid crystal display, a light emitting diode (LED) display, an organic light emitting diode (OLED) display, or the like.

The wave plate 200 is an element which converts a polarization state of light emitted from the display panel 100 to a polarization state appropriate to the optical path converting element 300. In an exemplary embodiment of the present invention, the wave plate 200 may be omitted in some cases, or may be configured to be integrated with the display panel 100. In an exemplary embodiment of the present invention, the wave plate 200 may be configured to be integrated with the optical path converting element 300.

The wave plate 200 may be an element which converts linearly polarized light emitted from the display panel 100 into circularly polarized light.

For example, the wave plate 200 may be a quarter wave plate (QWP).

The optical path converting element 300 may be any of optical systems, such as a lenticular lens, a parallax barrier, or the like, which configure an autostereoscopic image display device.

The optical path converting element 300 may convert the optical path in accordance with alignment of the liquid crystal by applying a voltage.

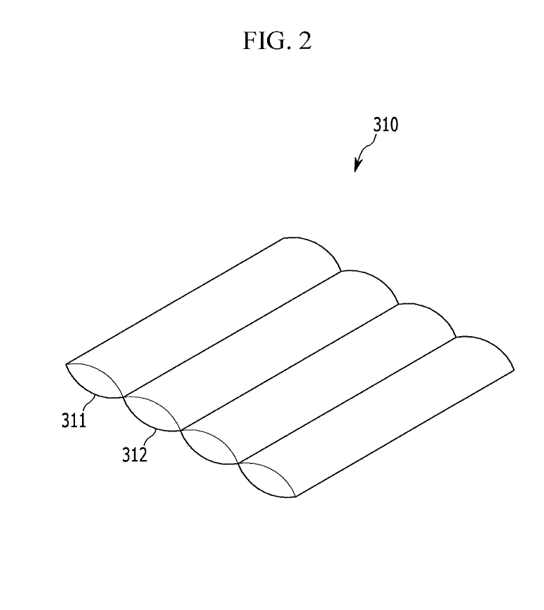

FIG. 2 is a view illustrating a shape of a lenticular lens 310 according to an exemplary embodiment of the present invention.

The lenticular lens 310 is formed by disposing one or more cylindrical lens units 311 and 312 having a major axis in one direction.

In FIG. 2, a fixed type lenticular lens 310 which is formed of glass or plastic is illustrated in an exemplary embodiment of the present invention.

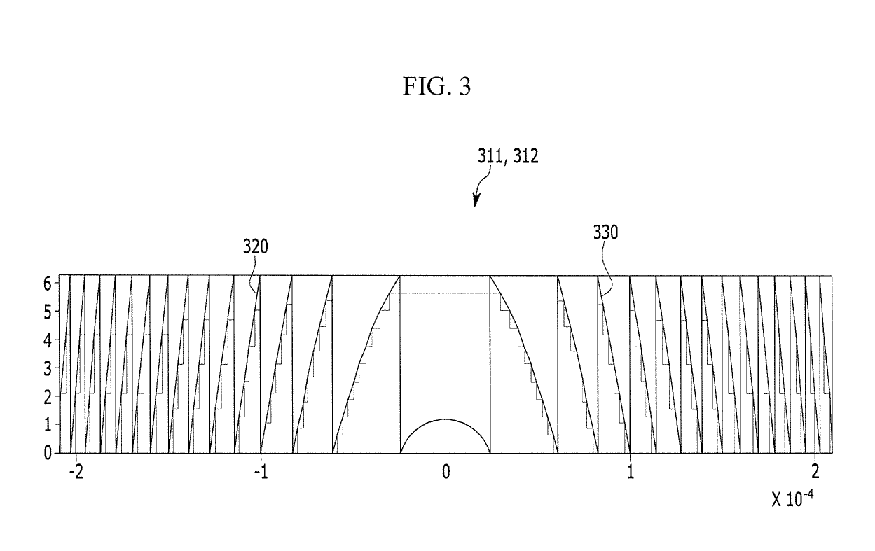

FIG. 3 is a view illustrating a phase distribution of a liquid crystal driving mode Fresnel lens according to an exemplary embodiment of the present invention.

The Fresnel lens refers to a lens which includes a plurality of concentric annular sections to reduce a thickness of the lens. The Fresnel lens may be a lens unit 311 or 312 of the lenticular lens 310.

Each of the lens units 311 and 312 may include a plurality of optical path converting units 320 and 330. The optical path converting unit 320 or 330 may be a prism.

The first optical path converting unit 330 may be a right prism of the Fresnel lens.

The second optical path converting unit 320 may be a left prism of the Fresnel lens.

For example, a slope direction of the prism may vary depending on an incident polarization state of light.

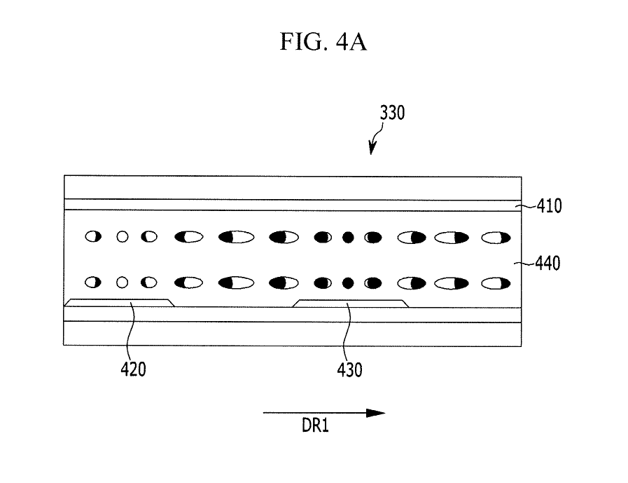

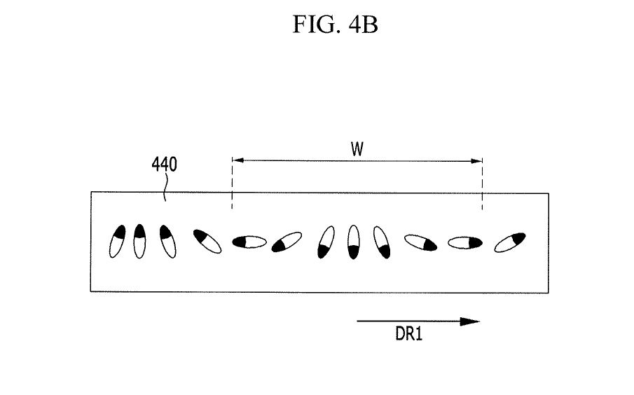

FIG. 4A is a side view illustrating a first optical path converting unit 330 according to an exemplary embodiment of the present invention, and FIG. 4B is a plan view of a liquid crystal layer 440 of the first optical path converting unit 330 according to an exemplary embodiment of the present invention.

Referring to FIGS. 4A and 4B, the first optical path converting unit 330 includes a first layer including electrodes 420 and 430, a second layer including an electrode 410, and a liquid crystal layer 440 interposed between the first layer and the second layer.

The first optical path converting unit 330 may further include an alignment layer, a spacer, and a driving thin film transistor (TFT).

Liquid crystal of a liquid crystal layer 440 may have a first state or a second state in accordance with voltages which are applied to the electrodes 410, 420, and 430 of the first layer and the second layer.

The first state is a state where no voltage is applied to the electrodes 410, 420, and 430 of the first layer and the second layer and the liquid crystal of the liquid crystal layer 440 may be vertically aligned in the first state.

The second state is a state where a predetermined voltage is applied to the electrodes 410, 420, and 430 of the first layer and the second layer in advance and the liquid crystal may be spirally aligned in a horizontal direction in accordance with the applied voltage. For example, in the second state, the liquid crystal may be horizontally aligned and the alignment of the liquid crystal may spirally rotate along a first direction DR1.

For example, a common voltage (e.g., a ground voltage) may be applied to the electrode 410 of the second layer, a relatively low voltage may be applied to the electrode 420 of the first layer, and a relatively high voltage may be applied to the electrode 430. In an exemplary embodiment of the present invention, a relatively high voltage may be applied to the electrode 420 and a relatively low voltage may be applied to the electrode 430.

In this case, the spiral alignment of the liquid crystal layer 440 illustrated in FIG. 4B may be referred to as a forward direction spiral alignment. For example, the forward direction spiral alignment may be an alignment in which the alignment of liquid crystal spirally rotates in a counterclockwise direction along the first direction DR1. Even though it may vary depending on the incident polarization state of light, the first optical path converting unit 330 may be a right prism of the Fresnel lens.

A period W may cause phase retardation. A range of the phase retardation may be 0 to □ or 0 to 2□ radian. The period W may represent a size of the unit prism.

The period W may vary depending on an applied voltage to the electrodes 410, 420, and 430 or arrangement thereof. When the period W is smaller, a slope of the prism becomes steeper, and when the period W is larger, the slope of the prism becomes gentler.

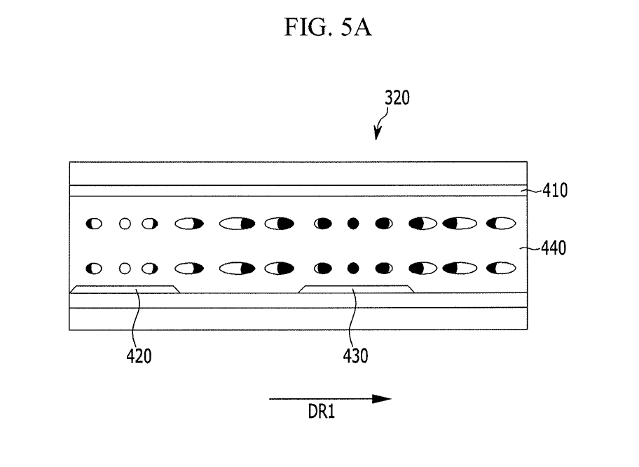

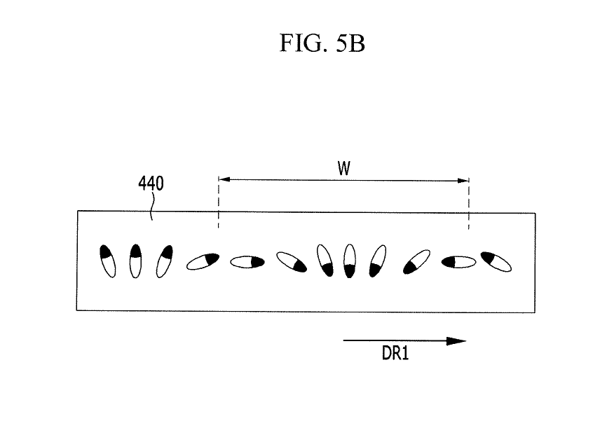

FIG. 5A is a side view illustrating a second optical path converting unit 320 according to an exemplary embodiment of the present invention, and FIG. 5B is a plan view of a liquid crystal layer 440 of the second optical path converting unit 320 according to an exemplary embodiment of the present invention.

Referring to FIGS. 5A and 5B, the second optical path converting unit 320 includes a first layer including electrodes 420 and 430, a second layer including an electrode 410, and a liquid crystal layer 440 interposed between the first layer and the second layer.

The second optical path converting unit 320 may further include an alignment layer, a spacer, a driving thin film transistor (TFT).

Liquid crystal of a liquid crystal layer 440 may have a first state or a second state in accordance with voltages which are applied to the electrodes 410, 420, and 430 of the first layer and the second layer.

The first state is a state where no voltage is applied to the electrodes 410, 420, and 430 of the first layer and the second layer and the liquid crystal of the liquid crystal layer 440 may be vertically aligned in the first state.

The second state is a state where a predetermined voltage is applied to the electrodes 410, 420, and 430 of the first layer and the second layer in advance and the liquid crystal may be spirally aligned in a horizontal direction in accordance with the applied voltage. For example, in the second state, the liquid crystal may be horizontally aligned and the alignment of the liquid crystal may spirally rotate along the first direction DR1.

For example, a common voltage (e.g., a ground voltage) may be applied to the electrode 410 of the second layer. A relatively low voltage may be applied to the electrode 420 of the first layer, and a relatively high voltage may be applied to the electrode 430, and thus, a forward direction spiral alignment may be formed first. Further, an intermediate process in which a voltage lower than the voltage of the electrode 410 is applied to the electrode 420 may be performed. Further, a relatively high voltage may be applied to the electrode 420 and a relatively low voltage may be applied to the electrode 430, and thus, the reverse direction spiral alignment may be formed, as, e.g., illustrated in FIG. 5B.

In this case, the spiral alignment of the liquid crystal layer 440 illustrated in FIG. 5B may be referred to as a reverse direction spiral alignment. For example, the reverse direction spiral alignment may be an alignment in which the alignment of liquid crystal spirally rotates in a clockwise direction along the first direction DR1. Even though it may vary depending on the incident polarization state of light, the second optical path converting unit 320 may be a left prism of the Fresnel lens.

A period W may cause phase retardation. A range of the phase retardation may be 0 to □ or 0 to 2□ radian. The period W may represent a size of the unit prism.

The period W may vary depending on an applied voltage to the electrodes 410, 420, and 430 or arrangement thereof. When the period W is smaller, a slope of the prism becomes steeper, and when the period is larger, the slope of the prism becomes gentler.

Referring back to FIG. 3, a plurality of first optical path converting units 330 and a plurality of second optical path converting units 320 are arranged to form a Fresnel lens as illustrated in FIG. 3 and a plurality of Fresnel lens may be a lenticular lens.

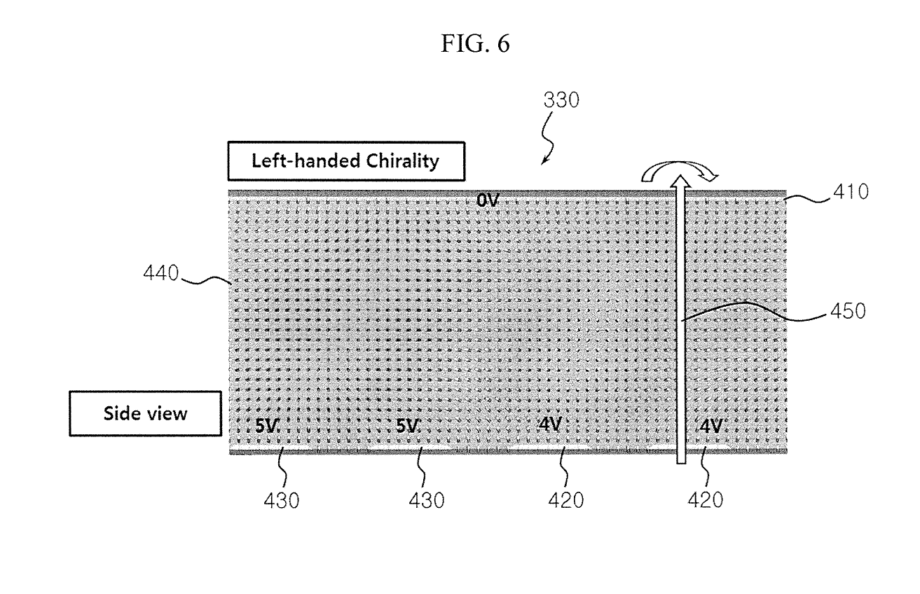

FIG. 6 is a view illustrating a case when a first optical path converting unit 330 has a left-handed chirality according to an exemplary embodiment of the present invention.

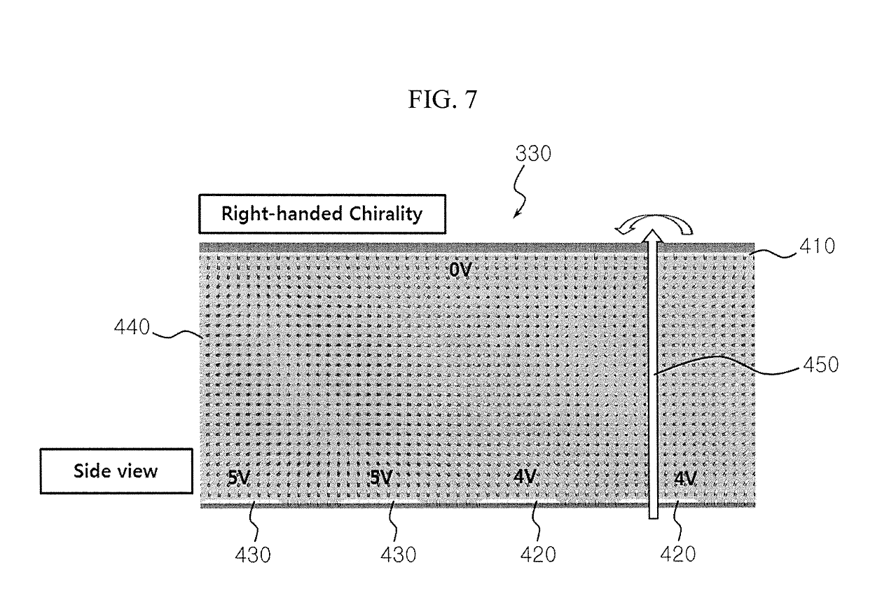

FIG. 7 is a view illustrating a case when a first optical path converting unit 330 has a right-handed chirality according to an exemplary embodiment of the present invention.

The chirality refers to a property of objects which are not superimposed, likes both hands which are reflected on a mirror. Further, in an exemplary embodiment of the present invention, the chirality may be understood as “twisted”.

The right-handed chirality or the left-handed chirality may be obtained.

The chirality may be obtained by adding chiral dopant. Chirality having different directions may be obtained depending on a kind of chiral dopant. For example, to form the right prism and the left prism, the optical path converting units 320 and 330 may have chirality in different directions.

Referring to FIG. 6, the first optical path converting unit 330 includes two electrodes 430 and two electrodes 420 per one period. In this case, a relatively high voltage point may be disposed between two electrodes 430 and a relatively low voltage point may be disposed between two electrodes 420.

As an example, the arrangements of the electrodes 410, 420, and 430 are illustrated in FIG. 6. In an exemplary embodiment of the present invention, an electrode having an intermediate voltage may further be provided to the arrangements of FIG. 6. When the electrode having the intermediate voltage is inserted, a slope plane of the prism, for example, phase retardation, may be gently changed.

In FIG. 6, an arrow 450 represents a progress direction of light and the liquid crystal has a left-handed chirality in the progress direction of light.

FIG. 7 is a view illustrating a case when a first optical path converting unit 330 having a right-handed chirality according to an exemplary embodiment of the present invention.

Referring to FIG. 7, the first optical path converting unit 330 includes two electrodes 430 and two electrodes 420 per one period. In this case, a relatively high voltage point may be disposed between two electrodes 430 and a relatively low voltage point may be disposed between two electrodes 420.

In FIG. 7, an arrow 450 represents a progress direction of light and the liquid crystal has a right-handed chirality in the progress direction of light.

As described above, a direction of chirality may be determined depending on a kind of chiral dopant.

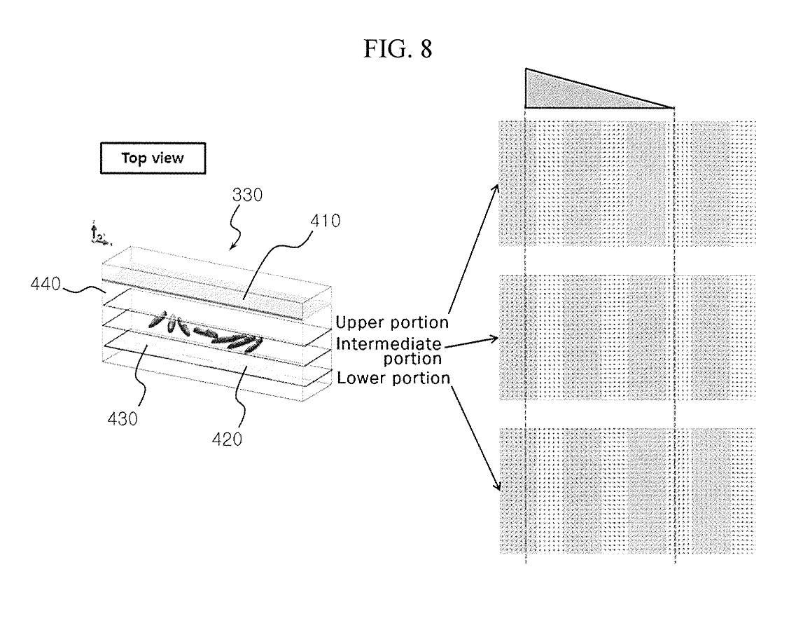

FIG. 8 is a view illustrating a first optical path converting unit 330 which does not have chirality according to an exemplary embodiment of the present invention.

Referring to FIG. 8, the liquid crystal layer 440 is illustrated to be divided into an upper portion, an intermediate portion, and a lower portion. The liquid crystal layer might not be physically divided into the upper portion, the intermediate portion, and the lower portion, but illustrated to be divided for the sake of easy description.

In the case of the liquid crystal which does not have chirality, even though a voltage is applied to the electrodes 410, 420, and 430, the upper portion, the intermediate portion, and the lower portion of the liquid crystal layer 440 may have substantially the same spiral alignment as each other, as illustrated in FIG. 8.

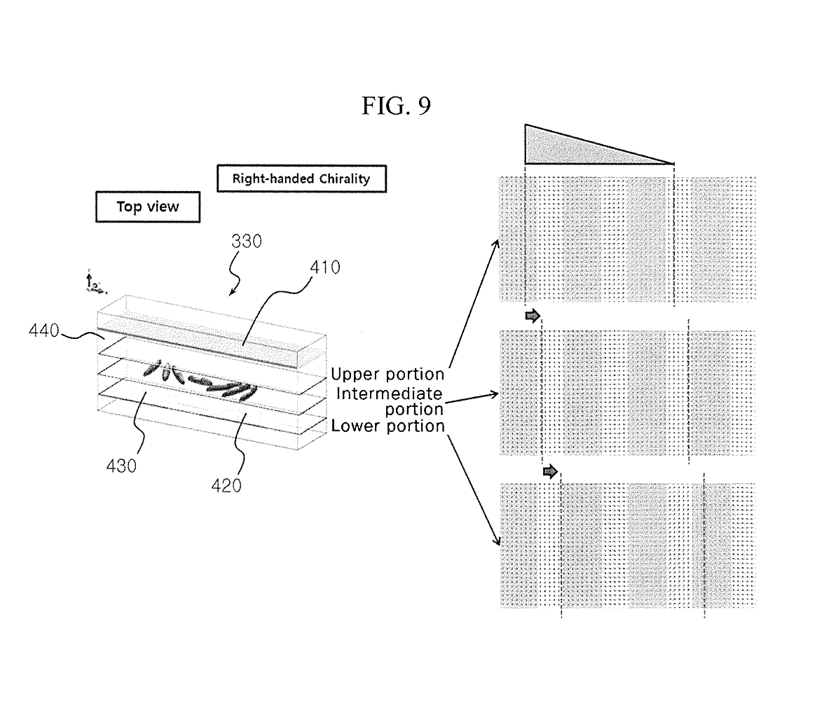

FIG. 9 is a view illustrating the first optical path converting unit 330 having a right-handed chirality according to an exemplary embodiment of the present invention.

Referring to FIG. 9, the upper portion, the intermediate portion, and the lower portion of the liquid crystal layer 440 have different spiral alignments from each other.

Since a liquid crystal director rotates with chirality, it may look as if the prism moves to the right and thus, it may look as if the formed spiral moves.

Due to the characteristic of the prism, the first optical path converting unit 330 according to an exemplary embodiment of the present invention shows an achromatic characteristic.

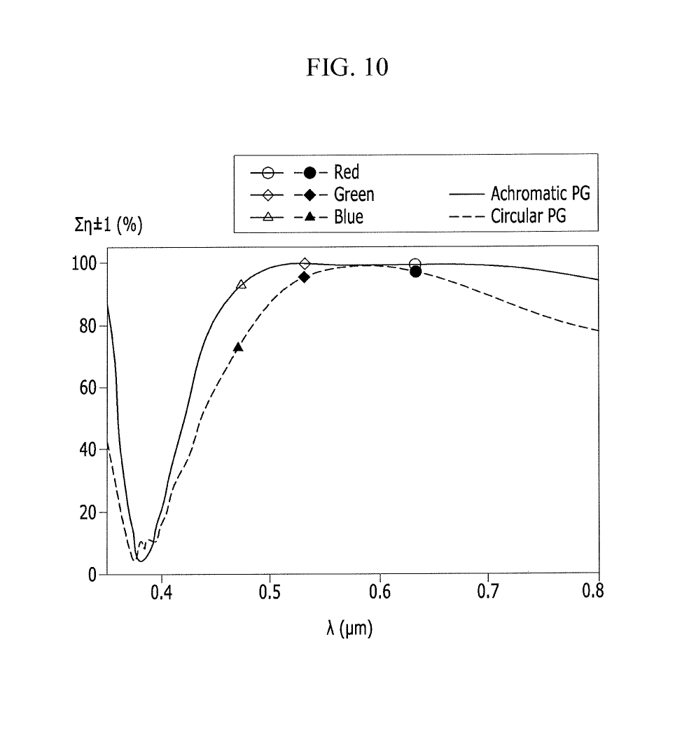

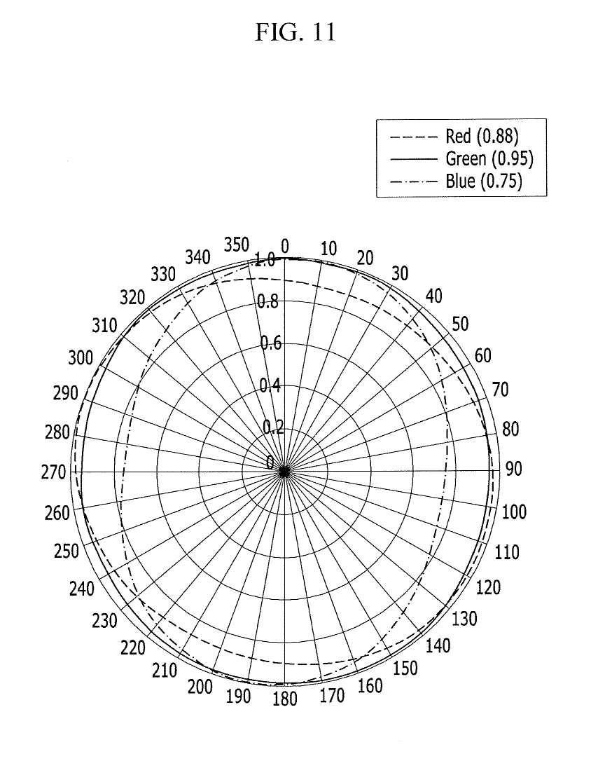

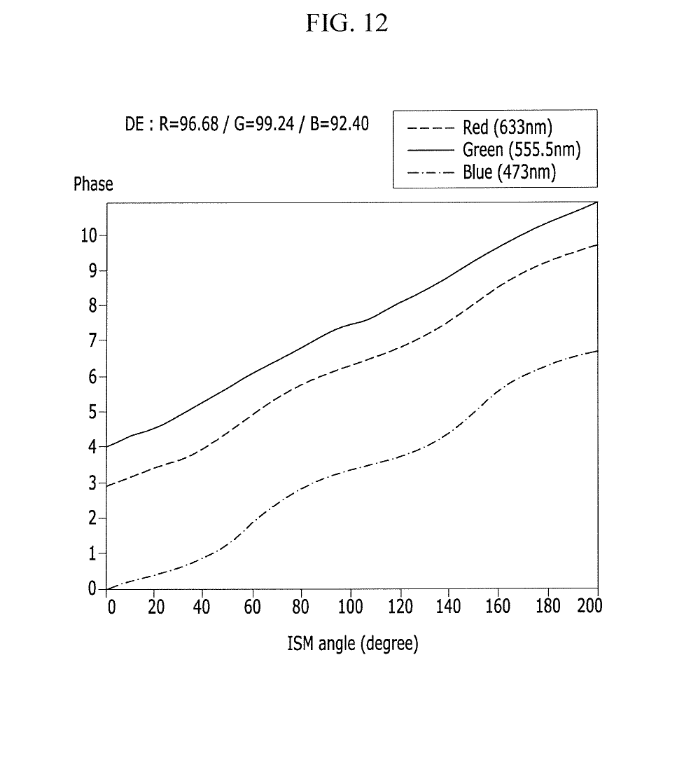

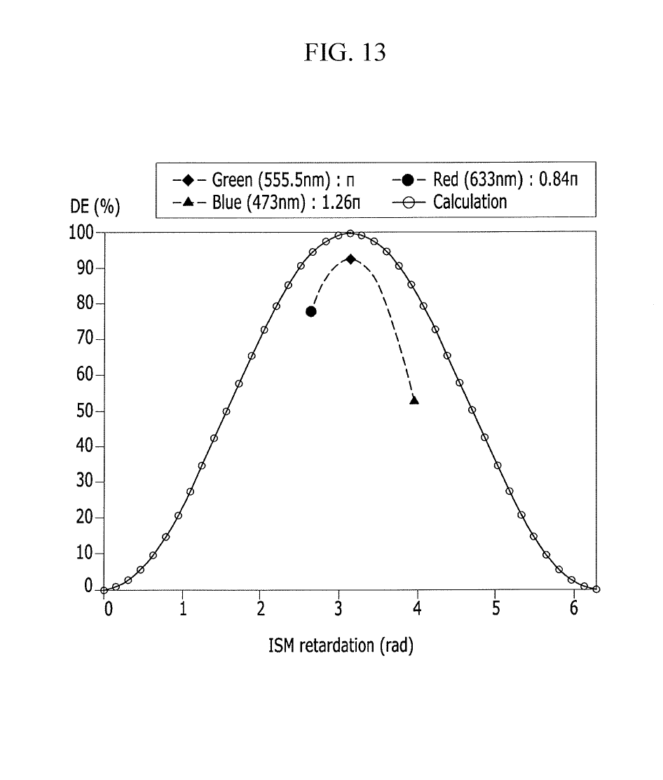

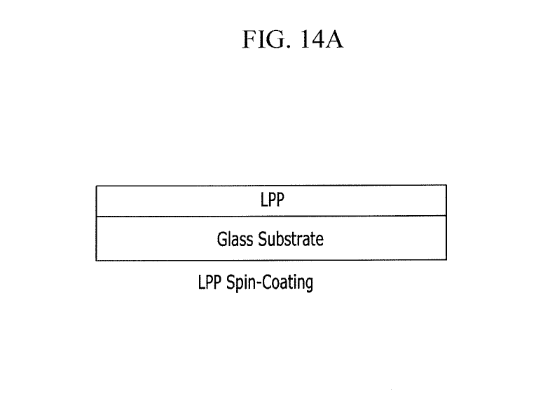

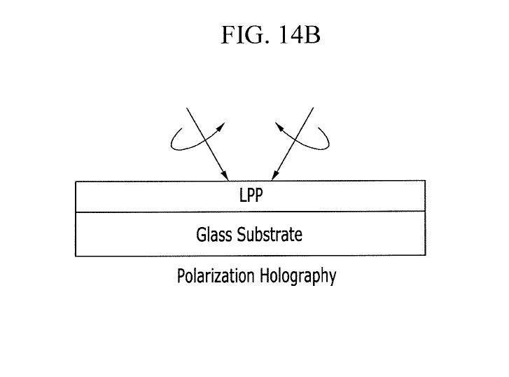

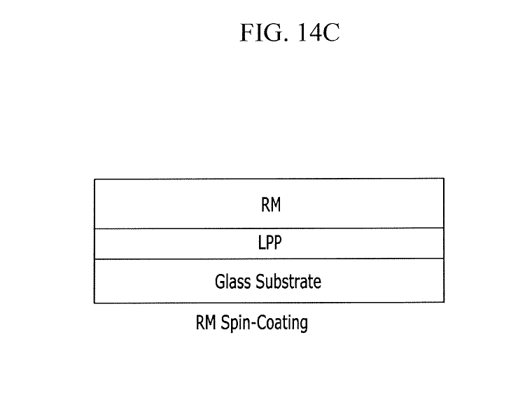

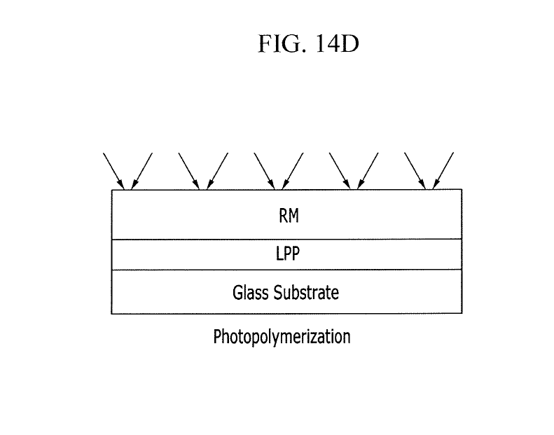

FIG. 10 is a view illustrating diffraction efficiency of an achromatic polarization grating PG and a circular polarization grating PG depending on a red wavelength, a green wavelength, and a blue wavelength.

FIG. 10 illustrates diffraction efficiency of the achromatic prism (e.g., the achromatic polarization grating PG or the circular polarization grating PG) when a twist angle is 70 degrees.

Referring to FIG. 10, in the achromatic polarization grating according to an exemplary embodiment of the present invention, 90% or higher diffraction efficiency is shown at the red wavelength, the green wavelength, and the blue wavelength.

According to an exemplary embodiment of the present invention, an achromatic optical path converting element which does not have a wavelength dispersion (e.g., a chromatic dispersion) may be provided and the optical path converting element may be manufactured by a simple method and may be on/off driven.

While this present invention has been described with reference to exemplary embodiments thereof, it will be understood that the present invention is not limited to the disclosed embodiments.

What is claimed is:

1. An optical path converting element, comprising:
a first layer including at least one first-layer electrode;
a second layer including at least one second-layer electrode; and
a liquid crystal layer interposed between the first layer and the second layer,
wherein liquid crystal of the liquid crystal layer has a first state or a second state in accordance with a voltage which is applied to the first-layer and second-layer electrodes,
wherein the liquid crystal of the liquid crystal layer is vertically aligned in the first state,
wherein the liquid crystal of the liquid crystal layer is horizontally aligned in the second state, the liquid crystal of the liquid crystal layer being spirally aligned along a first direction in the second state, and
wherein the liquid crystal of the liquid crystal layer has chirality.

2. The optical path converting element of claim 1, wherein the liquid crystal of the liquid crystal layer is spirally aligned in a clockwise direction in a plan view along the first direction in the second state to form a first optical path converting unit.

3. The optical path converting element of claim 1, wherein the liquid crystal of the liquid crystal layer is spirally aligned in a counterclockwise direction in a plan view along the first direction in the second state to form a second optical path converting unit.

4. An optical path converting element, comprising:
a first layer including at least one first-layer electrode;
a second layer including at least one second-layer electrode; and
a liquid crystal layer interposed between the first layer and the second layer,
wherein the liquid crystal layer has a first region and a second region,
wherein liquid crystal of the liquid crystal layer has a first state, a second state, or a third state in accordance with a voltage applied to the first-layer and second-layer electrodes,
wherein the liquid crystal of the liquid crystal layer is vertically aligned in the first state,
wherein the liquid crystal of the liquid crystal layer is horizontally aligned in the second state, the liquid crystal of the liquid crystal layer being spirally aligned in a first direction in the second state,
wherein the liquid crystal of the liquid crystal layer is horizontally aligned in the third state, the liquid crystal of the liquid crystal layer being spirally aligned in a second direction different from the first direction in the third state,
wherein the liquid crystal of the liquid crystal layer has chirality,
wherein the liquid crystal of the liquid crystal layer forms a first optical path converting unit which has the first state or the second state in the first region, and
wherein the liquid crystal of the liquid crystal layer forms a second optical path converting unit which has the first state or the third state in the second region.

5. The optical path converting element of claim 4, wherein the first optical path converting unit or the second optical path converting unit is disposed in a form of a Fresnel lens.

6. The optical path converting element of claim 4, wherein the first optical path converting unit or the second optical path converting unit is disposed in a form of a lenticular lens.

7. The optical path converting element of claim 4, wherein a size of the first optical path converting unit or the second optical path converting unit varies depending on a voltage which is applied to the first-layer and second-layer electrodes.

8. The optical path converting element of claim 4, wherein chirality of the liquid crystal of the first optical path converting unit is different from chirality of the liquid crystal of the second optical path converting unit.

9. The optical path converting element of claim 4, wherein a twisted direction due to the chirality of the liquid crystal of the first optical path converting unit is opposite to a twisted direction due to the chirality of the liquid crystal of the second optical path converting unit.

10. The optical path converting element of claim 1, wherein the chirality of the liquid crystal of the liquid crystal layer is obtained by adding chiral dopant.

11. A stereoscopic image display device, comprising:
a display panel;
a wave plate which is disposed on the display panel; and
an optical path converting element which is disposed on the wave plate,
wherein the optical path converting element is the optical path converting element of claim 4.

12. An optical path converting element, comprising:
a first layer including a first electrode and a second electrode;
a second layer including a third electrode; and
a liquid crystal layer interposed between the first layer and the second layer,
wherein liquid crystal of the liquid crystal layer forms a first optical path converting unit or a second optical path converting unit by applying voltages to the first through third electrodes of the first and second layers,
wherein the first optical path converting unit is formed by applying a first voltage to the first electrode and a second voltage higher than the first voltage to the second electrode,
wherein the second optical path converting unit is formed by applying the second voltage to the first electrode and the first voltage to the second electrode.

13. The optical path converting element of claim 12, wherein the liquid crystal of the liquid crystal layer has chirality.

14. The optical path converting element of claim 12, wherein the first optical path converting unit has the liquid crystal of the liquid crystal layer spirally aligned in one of a clockwise direction or a counterclockwise direction along a first direction.

15. The optical path converting element of claim 14, wherein the second optical path converting unit has the liquid crystal of the liquid crystal layer spirally aligned in an opposite direction to the direction of the first optical path converting unit.

16. The optical path converting element of claim 12, wherein the first optical path converting unit or the second optical path converting unit is disposed in a form of a Fresnel lens.

17. The optical path converting element of claim 12, wherein the first optical path converting unit or the second optical path converting unit is disposed in a form of a lenticular lens.

18. The optical path converting element of claim 12, wherein a size of the first optical path converting unit or the second optical path converting unit varies depending on levels of the first through third voltages.
